(19) United States
(12) Patent Application Publication
(10) Pub. No.: US 2009/0204687 A1
(43) Pub. Date: Aug. 13, 2009

(54) System and Field Device for Performing Operation of Linkage Between Application Programs

(75) Inventors: Kazuyuki Ito, Tokyo (JP); Akira Noguchi, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 12/308,144

(22) PCT Filed: Jun. 6, 2007
(86) PCT No.: PCT/JP2007/061459

§ 371 Date: Dec. 8, 2008

(30) Foreign Application Priority Data
Jun. 7, 2006 (JP) 2006-158017

(51) Int. Cl. G06F 15/16; G06F 9/46

(52) U.S. Cl. 709/218; 719/313

(57) ABSTRACT

In a system for performing an operation of linkage between application programs operating on each of the plural field devices mutually connected through a network, the system comprises a first field device and a second field device in which an application management function operating on an operating system respectively reads an application program, a slot and a connector out of a storage part and the application program, the slot and the connector are respectively activated and also the operating system in which the slot is registered in the application and the connector is registered in the slot runs, and the application programs respectively operating on the first field device and the second field device make connection to a virtual channel configured by a pair of the connector activated in the first field device and the connector activated in the second field device through a channel interface configured by a pair of the slot activated in the first field device and the slot activated in the second field device and perform sending and receiving of data.

### TECHNICAL FIELD

The present invention relates to a system for performing an operation of linkage between application programs operating on plural field devices mutually connected through a network and a field device for performing an operation of linkage between application programs operating on the same field device, and particularly to a system and a field device capable of easily implementing an operation of linkage between application programs.

### BACKGROUND ART

There are the following references as an art reference related to a system for performing an operation of linkage between application programs operating on plural field devices mutually connected through a network.

Patent Reference 1: Japanese Laid-open Patent Publication, JP-A-08-190513

Patent Reference 2: Japanese Laid-open Patent Publication, JP-A-2003-006155

FIG. 7 is a configuration block diagram showing one example of a system for performing an operation of linkage between application programs of such a related art.

In FIG. 7, reference numerals 1, 2, 3, 4 and 5 are distributed and arranged field devices such as a sensor, an actuator, a controller, a communication measuring device, a measuring device, a recorder or a server, and reference numeral 100 is a general-purpose network such as a LAN (Local Area Network), a WAN (Wide Area Network) or the Internet.

The field devices 1, 2, 3, 4 and 5 and the network 100 are mutually connected, respectively. Also, application programs (hereinafter simply called applications) shown by “AP01”, “AP02”, “AP03”, “AP04” and “AP05” in FIG. 7 operate on each of the field devices 1, 2, 3, 4 and 5.

An operation of the example of the related art shown in FIG. 7 will herein be described using FIGS. 8 and 9. FIG. 8 is an explanatory diagram explaining the operation of the example of the related art, and FIG. 9 is an explanatory diagram explaining that an application conforms to a common protocol.

Then, an application shown by “AP01”¹ in FIG. 8 operating on the field device 1 performs linkage such as data exchange with an application shown by “AP02” in FIG. 8 operating on the field device 2 by linkage (logical connection) shown by “RL11” in FIG. 8.

For example, the applications shown by “AP01”, “AP02”, “AP03”, “AP04” and “AP05” in FIG. 8 conform to a common protocol and as shown by “PR21” in FIG. 9, a specification method of a communication destination of linkage, the common protocol, etc. are respectively mounted in the application shown by “AP01” in FIG. 9 as shown in FIG. 9.

In such a state, the application shown by “AP01” in FIG. 8 communicates with the application shown by “AP02” in FIG. 8 through the field device 1, the network 100 and the field device 2 using the common protocol (“PR21” in FIG. 9) and thereby, the applications shown by “AP01” and “AP02” in FIG. 8 link mutually.

Similarly, the application shown by “AP02”1 in FIG. 8 operating on the field device 2 performs linkage such as data exchange with the application shown by “AP03” in FIG. 8 operating on the field device 3 by linkage (logical connection) shown by “RL12” in FIG. 8.

Similarly, the application shown by “AP03” in FIG. 8 operating on the field device 3 performs linkage such as data exchange with the application shown by “AP04” in FIG. 8 operating on the field device 4 by linkage (logical connection) shown by “RL13” in FIG. 8.

Finally, the application shown by “AP04” in FIG. 8 operating on the field device 4 performs linkage such as data exchange with the application shown by “AP05” in FIG. 8 operating on the field device 5 by linkage (logical connection) shown by “RL14” in FIG. 8.

As a result of this, the application operating on the field device communicates with the application operating on another field device through the field devices and the network using the common protocol and thereby, a system in which the applications operating on plural field devices distributed and arranged in the network link mutually can be constructed.

Also, FIG. 10 is a configuration block diagram showing another example of a system for performing an operation of linkage between application programs of a related art, and is particularly a system constructed in conformance with a field bus.

In FIG. 10, reference numeral 6 is a flowmeter which is a field device for measuring a flow rate of a flow path (not shown), and reference numeral 7 is a controller which is a field device for performing PID (Proportional Integral Differential) control, and reference numeral 8 is a valve adjuster which is a field device for controlling an opening of a valve (not shown) and adjusting a flow rate of a flow path (not shown).

The flowmeter 6, the controller 7 and the valve adjuster 8 are mutually connected to a network (not shown), respectively. Also, an application shown by “AP31” in FIG. 10 operates on the flowmeter 6.

Similarly, applications shown by “AP32”, “AP33” and “AP34” in FIG. 10 operate on the controller 7, and an application shown by “AP35” in FIG. 10 operates on the valve adjuster 8.

An operation of the example of the related art shown in FIG. 10 will herein be described. In each of the applications, function definition and interface definition are given in conformance with the field bus, and a distributed control application is constructed by combining these applications.

For example, the applications shown by “AP31” and “AP34” in FIG. 10 are functionally defined as AO (AnalogOutput function), and the applications shown by “AP32” and “AP35” in FIG. 10 are functionally defined as AI (AnalogInput function). Also, the application shown by “AP33” in FIG. 10 is functionally defined as PID (PID computation function).

The flowmeter 6 measures a flow rate of a flow path, and sends a measurement result to the controller 7 through the network (not shown) using the application (AnalogOutput function) shown by “AP31” in FIG. 10 operating on the flowmeter 6.

The controller 7 receives the measurement result from the flowmeter 6 using the application (AnalogInput function) shown by “AP32” in FIG. 10 operating on the controller 7, and performs PID computation based on a target value of the flow rate and the measurement result using the application (PID computation function) shown by “AP33” in FIG. 10 operating on the controller 7.

Also, the controller 7 sends a PID computation result to the valve adjuster 8 through the network (not shown) using the application (AnalogOutput function) shown by “AP34” in FIG. 10 operating on the controller 7.

Finally, the valve adjuster 8 receives the PID computation result from the controller 7 using the application (AnalogInput function) shown by “AP35” in FIG. 10 operating on the valve adjuster 8, and adjusts an opening of a valve based on the received PID computation result to control the flow rate of the flow path.

As a result of this, in each of the applications, function definition and interface definition are given in conformance with the field bus and also these applications are combined to construct a distributed control application and thereby, a system in which the applications operating on plural field devices distributed and arranged in the network link mutually can be constructed.

### DISCLOSURE OF THE INVENTION

### Problems that the Invention is to Solve

However, in the example of the related art shown in FIG. 7, it is linkage by the common protocol, so that there was a problem of requiring protocol mounting etc. every application operating on each of the field devices as shown in FIG. 9.

Also, in the example of the related art shown in FIG. 10, the function definition etc. in conformance with the field bus specialize in construction of the distributed control application, so that there was a problem that it is not easy to construct a general-purpose application using the function definition etc. in conformance with the field bus.

Therefore, a problem that the invention is to solve is to implement a system and a field device capable of easily implementing an operation of linkage between application programs.

### Means for Solving the Problems

In order to achieve such a problem, in a system for performing an operation of linkage between application programs operating on each of the plural field devices mutually connected through a network, a system of the invention comprises a first field device and a second field device in which an application management function operating on an operating system respectively reads an application program, a slot and a connector out of a storage part and the application program, the slot and the connector are respectively activated and also the operating system in which the slot is registered in the application and the connector is registered in the slot runs, and the application programs respectively operating on the first field device and the second field device make connection to a virtual channel configured by a pair of the connector activated in the first field device and the connector activated in the second field device through a channel interface configured by a pair of the slot activated in the first field device and the slot activated in the second field device and perform sending and receiving of data.

Therefore, an operation of linkage between application programs can easily be implemented.

In the system, the plural slots are registered in the application program.

Therefore, an operation of linkage of more complicated applications can easily be implemented.

In the system, the plural connectors are registered in the one slot registered in the application.

Therefore, an operation of linkage of more complicated applications can easily be implemented.

In the system, the plural applications operating on the same field device make connection to a virtual channel configured by a pair of the connectors through a channel interface configured by a pair of the slots and perform virtual data sending and receiving.

Therefore, an operation of linkage between application programs can easily be implemented.

In the system, a parameter reference processing function of referring to a preset connector parameter and invoking and executing necessary processing is mounted in the connector.

Therefore, it is compatible with a difference in network environment by changing the connector parameter set in the connector.

In the system, in the case of deciding that sending and receiving of the data are not linkage between different field devices by referring to the connector parameter, the parameter reference processing function invokes processing of the inside of the same field device and executes the processing and in the case of deciding that environment of the network is not an IP network by referring to the connector parameter, processing for non-IP network is invoked and the processing is executed and in the case of deciding that environment of the network is the IP network by referring to the connector parameter, processing for IP network is invoked and in the case of deciding that environment of the network is not a LAN by referring to the connector parameter, WAN-capable processing is invoked and the processing is executed together with the processing for IP network and in the case of deciding that environment of the network is the LAN by referring to the connector parameter, LAN-capable processing is invoked and the processing is executed together with the processing for IP network.

Therefore, it is compatible with a difference in network environment by changing the connector parameter set in the connector.

In the system, the connector mounted compatibly with a non-IP network is activated when environment of the network is not an IP network, and the connector mounted compatibly with a WAN is activated when environment of the network is the IP network and is not a LAN, and the connector mounted compatibly with the LAN is activated when environment of the network is the IP network and is the LAN.

Therefore, it is compatible with a difference in network environment by changing the activated connector to a connector of different mounting.

In a field device for performing an operation of linkage between plural application programs operating on the same field device, a field device of the invention comprises an operating system, an application management function, and a storage part, and the application management function operating on the operating system respectively reads a first application program, a first slot and a first connector out of the storage part and the first application program, the first slot and the first connector are respectively activated and also the operating system in which the first slot is registered in the first application program and the first connector is registered in the first slot runs and the application management function operating on the operating system respectively reads a second application program, a second slot and a second connector out of the storage part and the second application program, the second slot and the second connector are respectively activated and also the operating system in which the second slot is registered in the second application program and the second connector is registered in the second slot runs, and the first application program and the second application program make connection to a virtual channel configured by a pair of the first connector and the second connector through a channel interface configured by a pair of the first slot and the second slot and perform sending and receiving of data.

Therefore, an operation of linkage between application programs can easily be implemented.

### EFFECT OF THE INVENTION

There are the following effects according to the invention.

According to a system and a field device of the invention, an application management function reads an application out of a storage part and activates the application and also, respectively reads a slot and a connector out of the storage part and respectively activates the slot and the connector and the application makes connection to a virtual channel configured by a pair of the connectors through a channel interface configured by a pair of the slots and perform virtual data sending and receiving and thereby, an operation of linkage between application programs can easily be implemented.

Also, according to the system and the field device of the invention, plural slots are registered in one application or plural connectors are registered in one slot registered in an application and thereby, an operation of linkage of more complicated applications can easily be implemented.

Also, according to the system of the invention, a parameter reference processing function of referring to a connector parameter set in a connector and invoking and executing necessary processing is mounted in the connector and thereby, it is compatible with a difference in network environment by changing the connector parameter set in the connector without changing the connector.

### BRIEF DESCRIPTION OF THE DRAWINGS

FIG. 1 is a configuration block diagram showing one embodiment of a field device configuring a system for performing an operation of linkage between application programs according to the invention.

FIG. 2 is an explanatory diagram explaining an operation of linkage between two field devices.

FIG. 3 is an explanatory diagram explaining a logical configuration of linkage of applications respectively operating on the two field devices.

FIG. 4 is an explanatory diagram explaining a logical configuration of various linkages of applications respectively operating on plural field devices.

FIG. 5 is an explanatory diagram explaining an operation of linkage between plural applications operating on the same field device.

FIG. 6 is a flow diagram explaining an operation of a parameter reference processing function mounted in a connector.

FIG. 7 is a configuration block diagram showing one example of a system for performing an operation of linkage between application programs of a related art.

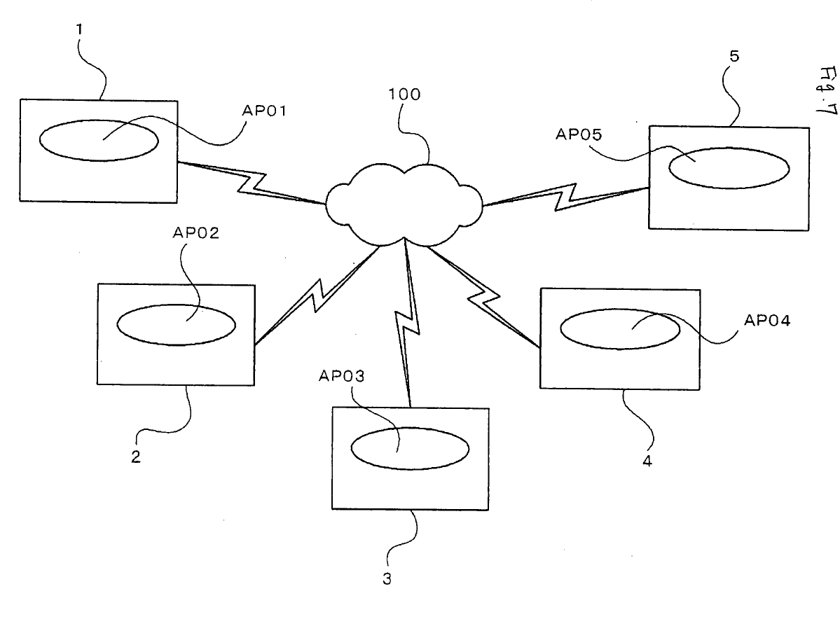

FIG. 8 is an explanatory diagram explaining an operation of the example of the related art.

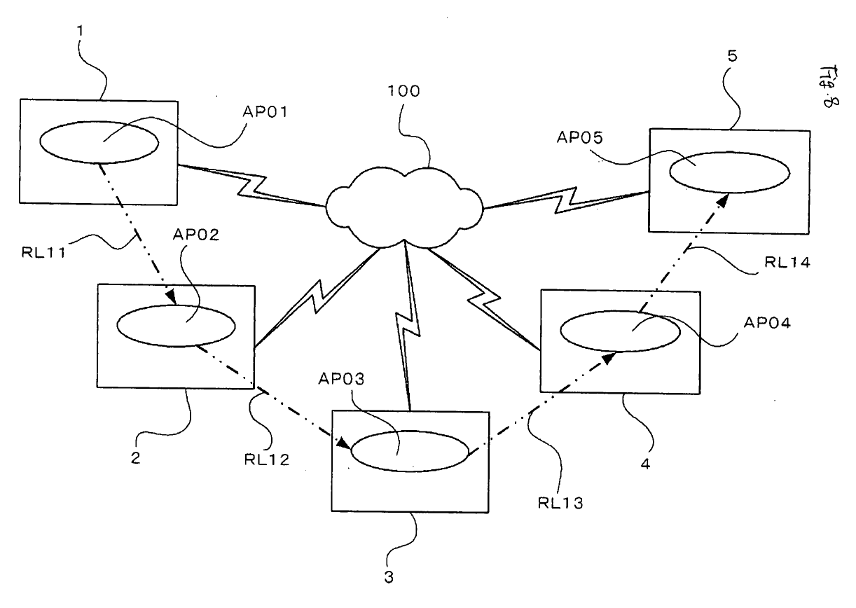

FIG. 9 is an explanatory diagram explaining that an application conforms to a common protocol.

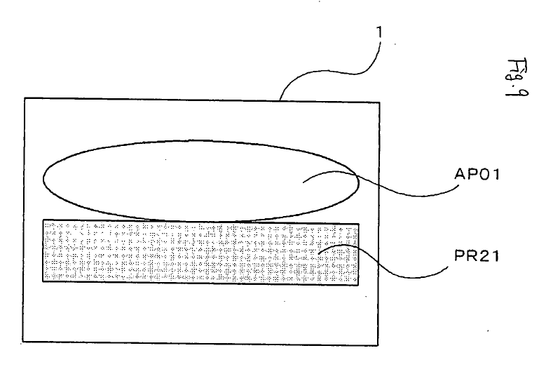

FIG. 10 is a configuration block diagram showing another example of a system for performing an operation of linkage between application programs of a related art.

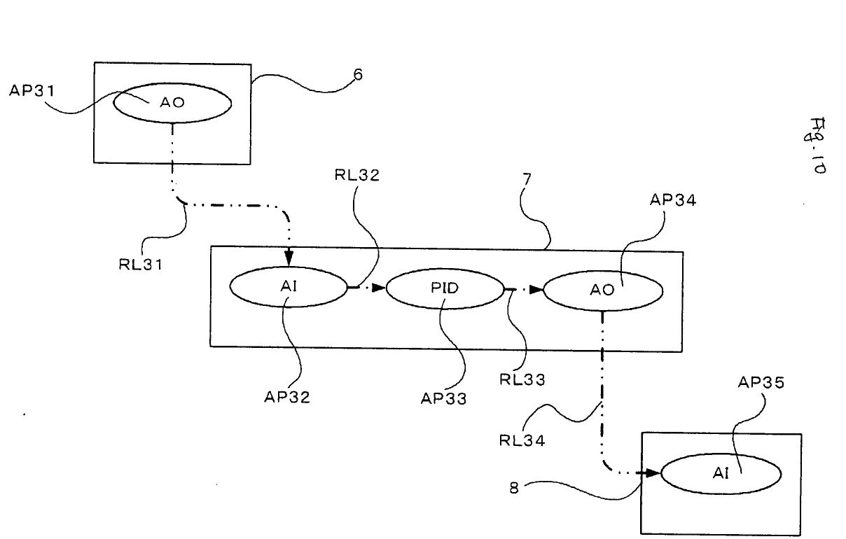

### DESCRIPTION OF REFERENCE NUMERALS AND SIGNS

1,2,3,4,5,9,10 FIELD DEVICE
6 FLOWMETER
7 CONTROLLER
8 VALVE ADJUSTER
100 NETWORK

### BEST MODE FOR CARRYING OUT THE INVENTION

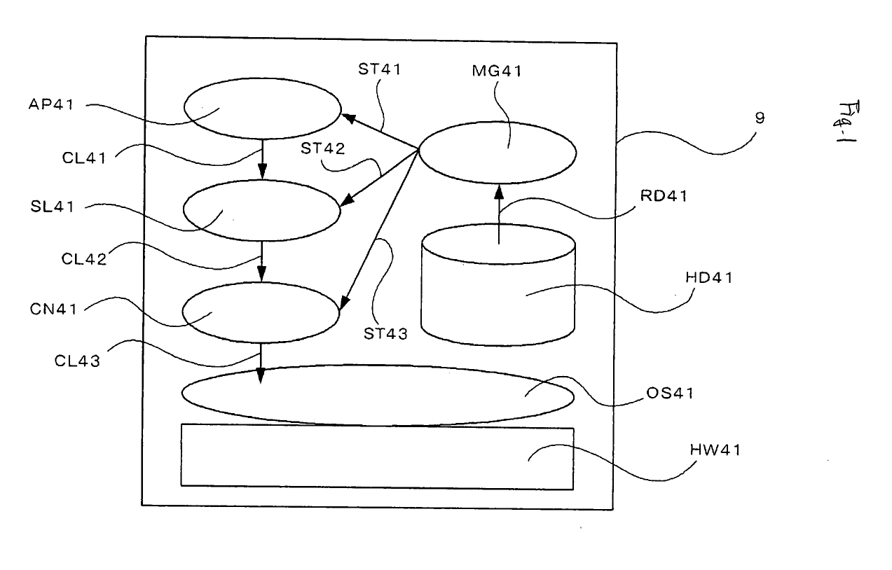

The invention will hereinafter be described in detail using the drawings. FIG. 1 is a configuration block diagram showing one embodiment of a field device configuring a system for performing an operation of linkage between application programs according to the invention.

In FIG. 1, reference numeral 9 is a field device such as a sensor, an actuator, a controller, a communication measuring device, a measuring device, a recorder or a server. Also, the field device 9 is mutually connected to a network (not shown) and other field devices (not shown) are also mutually connected to the network (not shown).

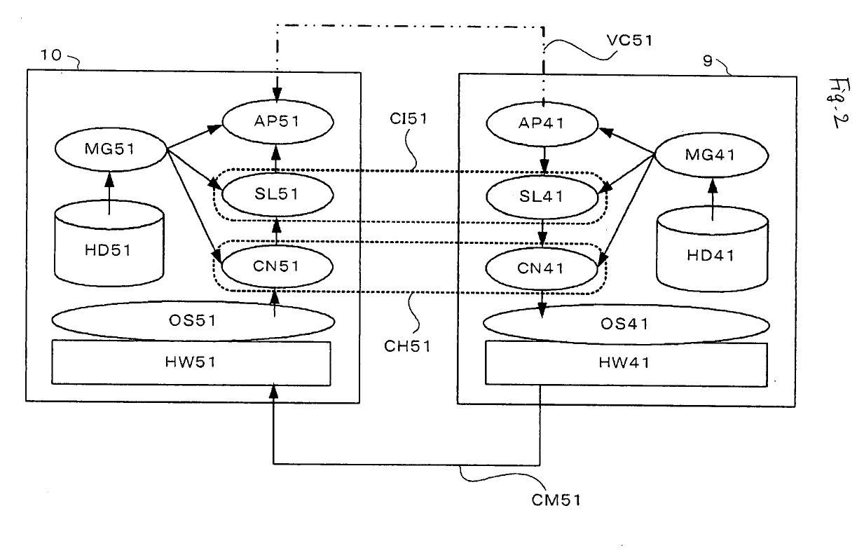

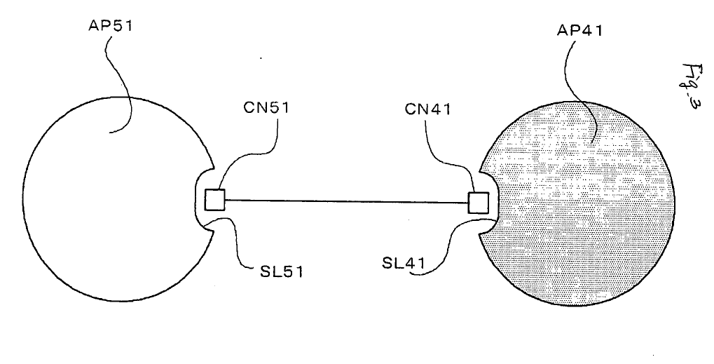

An operation of the embodiment shown in FIG. 1 will herein be described using FIGS. 2 and 3. FIG. 2 is an explanatory diagram explaining an operation of linkage between two field devices, and FIG. 3 is an explanatory diagram explaining a logical configuration of linkage of applications respectively operating on the two field devices.

In the field device 9, an operating system (hereinafter simply called an OS) shown by “OS41” in FIG. 1 runs on hardware such as RAM (Random Access Memory) or a CPU (Central Processing Unit) of the field device 9 shown by “HW41” in FIG. 1.

Then, an application shown by “AP41” in FIG. 1, a slot program (hereinafter simply called a slot) shown by “SL41” in FIG. 1, a connector program (hereinafter simply called a connector) shown by “CN41” in FIG. 1 and an application management function shown by “MG41” in FIG. 1 respectively operate on the OS shown by “OS41” in FIG. 1.

Here, the slot means amounting program for interfacing between the application and the connector. By using the slot, plural connectors can be connected to the application or the connector can be replaced freely without changing the application.

For example, in the case of activating the application shown by “AP41” in FIG. 1, the application management function shown by “MG41” in FIG. 1 reads an application out of a storage part such as a hard disk shown by “HD41” in FIG. 1 as shown by “RD41” in FIG. 1 and activates the application as shown by “ST41” in FIG. 1.

Similarly, the application management function shown by “MG41” in FIG. 1 respectively reads a slot and a connector out of the storage part such as the hard disk shown by “HD41” in FIG. 1 as shown by “RD41” in FIG. 1 and respectively activates the slot and the connector as shown by “ST42” and “ST43” in FIG. 1.

The connector shown by “CN41” in FIG. 1 is registered in the slot shown by “SL41” in FIG. 1 at the time of activation, and the slot shown by “SL41” in FIG. 1 is registered in the application shown by “AP41” in FIG. 1 at the time of activation.

Then, the application shown by “AP41”¹ in FIG. 1 invokes the slot shown by “SL41” in FIG. 1 registered as shown by “CL41” in FIG. 1, and the slot shown by “SL41” in FIG. 1 invokes the connector shown by “CN41” in FIG. 1 registered as shown by “CL42” in FIG. 1, and the connector shown by “CN41” in FIG. 1 invokes the OS shown by “OS41” in FIG. 1 as shown by “CL43” in FIG. 1.

Next, an operation of linkage between two field devices will be described. In FIG. 2, reference numeral 10 is a field device having the same configuration as that of the field device 9, and the same signs as those of FIG. 1 are assigned to reference numeral 9, “HW41”, “OS41”, “AP41”, “SL41”, “CN41”, “MG41” and “HD41”.

Also, “HW51” in FIG. 2 is hardware such as RAM or a CPU of the field device 10, and “OS51” in FIG. 2 is an OS running on the hardware shown by “HW51” in FIG. 2, and “AP51”, “SL51”, “CN51” and “MG51” in FIG. 2 are respectively an application, a slot, a connector and an application management function operating on the OS shown by “OS51” in FIG. 2, and “HD51” in FIG. 2 is a storage part such as a hard disk.

Also, the field device 9 and the field device 10 are mutually connected to a network (not shown), respectively.

A pair of the connectors shown by “CN41” and “CN51” in FIG. 2 configure a channel shown by “CH51” in FIG. 2, and a pair of the slots shown by “SL41” and “SL51” in FIG. 2 configure a channel interface capable of being connected to the channel shown by “CI51” in FIG. 2.

Also, here, the channel shown by “CH51” in FIG. 2 is a virtual (logical) communication path, and the channel interface shown by “CI51” in FIG. 2 is an interface for being connected to the channel shown by “CH51” in FIG. 2.

Similarly to the above, for example, in the case of activating the application shown by “AP51” in FIG. 2, the application management function shown by “MG51” in FIG. 2 reads an application out of the storage part such as the hard disk shown by “HD51” in FIG. 2 and activates the application.

Similarly, the application management function shown by “MG51” in FIG. 2 respectively reads a slot and a connector out of the storage part such as the hard disk shown by “HD51” in FIG. 2 and respectively activates the slot and the connector.

Also, the connector shown by “CN51” in FIG. 2 is registered in the slot shown by “SL51” in FIG. 2 at the time of activation, and the slot shown by “SL51” in FIG. 2 is registered in the application shown by “AP51” in FIG. 2 at the time of activation.

Then, the application shown by “AP51” in FIG. 2 invokes the slot shown by “SL51” in FIG. 2 registered, and the slot shown by “SL51” in FIG. 2 invokes the connector shown by “CN51” in FIG. 2 registered, and the connector shown by “CN51” in FIG. 1 invokes the OS shown by “OS51” in FIG. 2.

The case of performing linkage between the application shown by “AP41” in FIG. 2 and the application shown by “AP51” in FIG. 2 under such circumstances is assumed. Concretely, the case of sending data from the application shown by “AP41” in FIG. 2 to the application shown by “AP51” in FIG. 2 is assumed.

The application shown by “AP41” in FIG. 2 passes the sent data to the slot shown by “SL41” in FIG. 2, and the slot shown by “SL41” in FIG. 2 relays the data to the connector shown by “CN41” in FIG. 2.

Then, the connector shown by “CN41” in FIG. 2 conducts communication (data sending) with the hardware (“HW51”) of the field device 10 as shown by “CM51” in FIG. 2 using the hardware (“HW41”) of the field device 9 through the OS shown by “OS41” in FIG. 2.

On the other hand, the connector shown by “CN51” in FIG. 2 captures the received data using the hardware (“HW51”) of the field device 10 through the OS shown by “OS51” in FIG. 2 and passes the data to the slot shown by “SL51” in FIG. 2, and the slot shown by in FIG. 2 relays the data to the application shown by “AP51” in FIG. 2.

At this time, the data is sent and received virtually as shown by “VC51” in FIG. 2 between the application shown by “AP41” in FIG. 2 and the application shown by “AP51” in FIG. 2.

For example, the application shown by “AP41” in FIG. 3 makes connection to a virtual channel configured by a pair of the connectors shown by “CN41” and “CN51” in FIG. 3 through the channel interface shown by “SL41” in FIG. 3 (concretely, one slot of the channel interface configured by a pair of the slots shown by “SL41” in FIG. 3 and “SL51” in FIG. 3) and virtually sends the data to the application shown by “AP51” in FIG. 2.

Similarly, for example, the application shown by “AP51” in FIG. 3 makes connection to the virtual channel configured by a pair of the connectors shown by “CN41” and “CN51” in FIG. 3 through the channel interface shown by “SL51” in FIG. 3 (concretely, the other slot of the channel interface configured by a pair of the slots shown by “SL41” in FIG. 3 and “SL51” in FIG. 3) and virtually receives the data from the application shown by “AP41” in FIG. 2.

As a result of this, the application management function reads an application out of the storage part and activates the application and also respectively reads a slot and a connector out of the storage part and respectively activates the slot and the connector and the application makes connection to a virtual channel configured by a pair of connectors through a channel interface configured by a pair of slots and performs virtual data sending and receiving and thereby, an operation of linkage between application programs can easily be implemented.

In addition, in the embodiment shown in FIG. 1, the operation of linkage between the applications respectively operating on the two field devices is described, but plural slots may naturally be registered in one application. Also, plural connectors may be registered in one slot registered in an application.

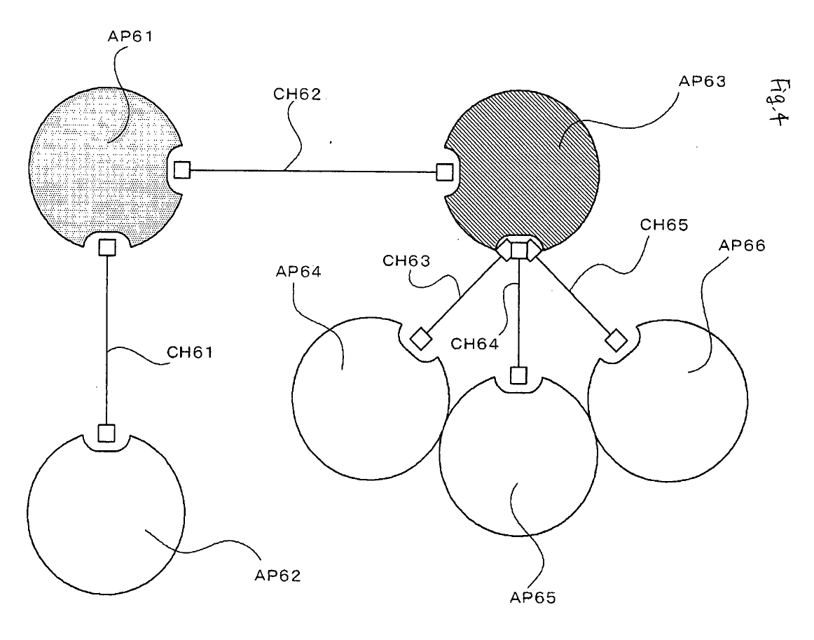

For example, FIG. 4 is an explanatory diagram explaining a logical configuration of various linkages of applications respectively operating on such plural field devices. In FIG. 4, “AP61”, “AP62”, “AP63”, “AP64”, “AP65” and “AP66”¹ are applications operating on each of the field devices (not shown).

Also, in FIG. 4, “CH61”, “CH62”, “CH63”, “CH64” and “CH65” are virtual channels respectively configured by a pair of connectors. Incidentally, signs are not assigned to slots and connectors in FIG. 4 for simplicity of explanation.

Two slots are registered in the application shown by “AP61” in FIG. 4, and the application shown by “AP61” in FIG. 4 links to the application shown by “AP62” in FIG. 4 by the virtual channel shown by “CH61” in FIG. 4.

More concretely, the application shown by “AP61” in FIG. 4 makes connection to the virtual channel shown by “CH61” in FIG. 4 through a channel interface configured by one slot registered in the application shown by “AP61” in FIG. 4 and a slot registered in the application shown by “AP62” in FIG. 4.

Simultaneously, the application shown by “AP61” in FIG. 4 links to the application shown by “AP63” in FIG. 4 by the virtual channel shown by “CH62” in FIG. 4.

More concretely, the application shown by “AP61” in FIG. 4 makes connection to the virtual channel shown by “CH62” in FIG. 4 through a channel interface configured by the other slot registered in the application shown by “AP61” in FIG. 4 and one slot registered in the application shown by “AP63” in FIG. 4.

Also, the application shown by “AP63” in FIG. 4 links to the applications shown by “AP64”, “AP65” and “AP66” in FIG. 4 by the virtual channels shown by “CH63”, “CH64” and “CH65” in FIG. 4.

More concretely, the application shown by “AP63” in FIG. 4 respectively makes connection to the virtual channels shown by “CH63”, “CH64” and “CH65” in FIG. 4 through three channel interfaces configured by the other slot registered in the application shown by “AP63” in FIG. 4 and respective slots registered in the three applications shown by “AP64”, “AP65” and “AP66” in FIG. 4.

As a result of this, an operation of linkage of more complicated applications can easily be implemented by registering plural slots in one application or registering plural connectors in one slot registered in an application.

Also, in the embodiment shown in FIG. 1, the operation of linkage between the applications respectively operating on the two field devices is described, but an operation of linkage between plural applications operating on the same field device may naturally be performed.

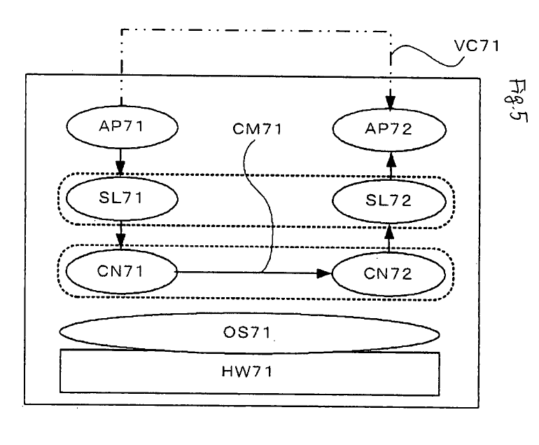

FIG. 5 is an explanatory diagram explaining an operation of linkage between plural applications operating on such same field device. “HW71” in FIG. 5 is hardware such as RAM or a CPU of the field device, and “OS71” in FIG. 5 is an OS running on the hardware shown by “HW71” in FIG. 5, and “AP71” and “AP72” in FIG. 5 are respectively applications operating on the OS shown by “OS71” in FIG. 5.

Also, “SL71” and “SL72” in FIG. 5 are respectively slots operating on the OS shown by “OS71” in FIG. 5, and “CN71” and “CN72” in FIG. 5 are respectively connectors operating on the OS shown by “OS71” in FIG. 5.

However, in FIG. 5, description of an application management function and a storage part is omitted for simplicity of explanation.

The case of performing linkage between the application shown by “AP71” in FIG. 5 and the application shown by “AP72” in FIG. 5 is assumed. Concretely, the case of sending data from the application shown by “AP71” in FIG. 5 to the application shown by “AP72” in FIG. 5 is assumed.

The application shown by “AP71” in FIG. 5 passes the sent data to the slot shown by “SL71” in FIG. 5, and the slot shown by “SL71” in FIG. 5 relays the data to the connector shown by “CN71” in FIG. 5.

Then, the connector shown by “CN71” in FIG. 5 directly conducts communication (data sending) with the connector shown by “CN72” in FIG. 5 operating on the OS shown by “OS71” in FIG. 5.

On the other hand, the connector shown by “CN72” in FIG. 5 passes the data directly received from the connector shown by “CN71” in FIG. 5 to the slot shown by “SL72” in FIG. 5, and the slot shown by “SL72” in FIG. 5 relays the data to the application shown by “AP72” in FIG. 5.

At this time, the data is sent and received virtually as shown by “VC71” in FIG. 5 between the application shown by “AP71” in FIG. 5 and the application shown by “AP72” in FIG. 5.

For example, the application shown by “AP71” in FIG. 5 makes connection to a virtual channel configured by a pair of the connectors shown by “CN71” and “CN72” in FIG. 5 through a channel interface shown by “SL71” in FIG. 5 (concretely, one slot of the channel interface configured by a pair of the slots shown by “SL71” in FIG. 5 and “SL72” in FIG. 5) and virtually sends the data to the application shown by “AP72” in FIG. 5.

Similarly, for example, the application shown by “AP72” in FIG. 5 makes connection to the virtual channel configured by a pair of the connectors shown by “CN71” and “CN72”¹ in FIG. 5 through the channel interface shown by “SL72” in FIG. 5 (concretely, the other slot of the channel interface configured by a pair of the slots shown by “SL71” in FIG. 5 and “SL72” in FIG. 5) and virtually receives the data from the application shown by “AP71” in FIG. 5.

Also, each of the connectors performs processing dependent on the hardware or the OS operating respectively, so that each of the connectors depends on a difference in environment of a network to which the field device is connected.

More concretely, there is a difference in that the network environment is an IP (Internet Protocol) network or a non-IP network, and there is a difference in that the network environment is a LAN or a WAN even for the IP network.

Even in such a case, according to the embodiment, it is compatible with a difference in network environment by changing only a connector without changing an application or a slot.

That is, when the network environment is not the IP network, a change to a connector mounted compatibly with the non-IP network is made and when the network environment is the IP network and is not the LAN, a change to a connector mounted compatibly with the WAN is made and when the network environment is the IP network and is the LAN, a change to a connector mounted compatibly with the LAN is made. Therefore, it is compatible with the difference in the network environment by changing the read and activated connector to a connector of different mounting.

Also, a parameter reference processing function of referring to a connector parameter set in a connector and invoking and executing necessary processing is mounted in the connector and thereby, it is compatible with the difference in the network environment by changing the connector parameter set in the connector without changing the connector.

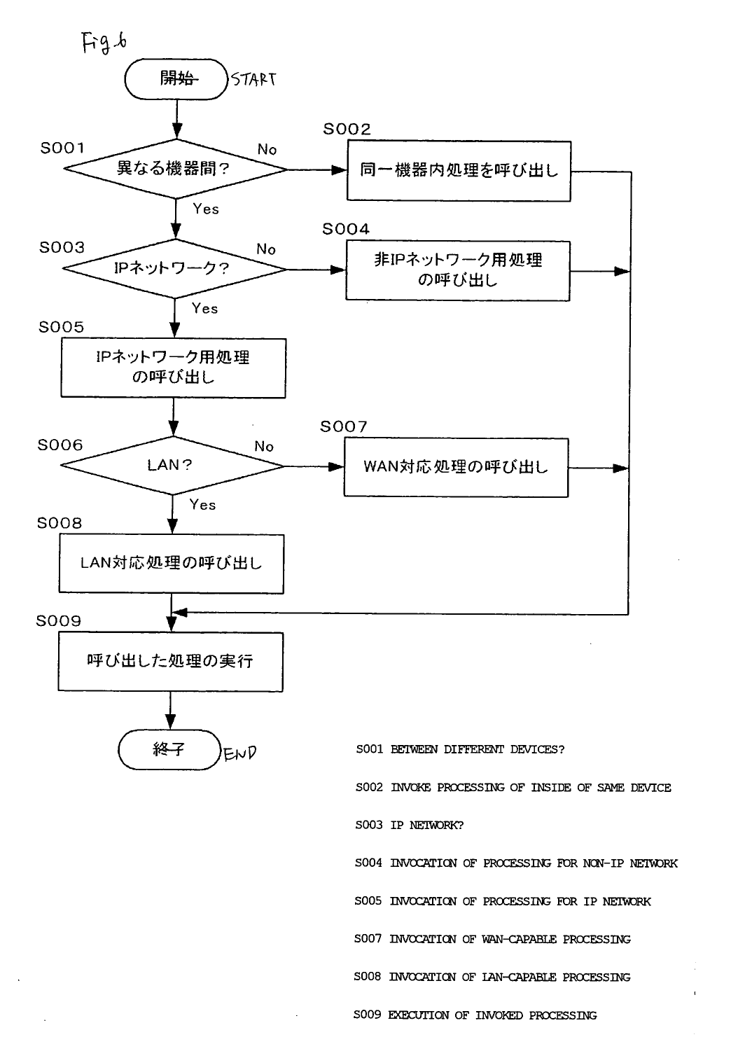

FIG. 6 is a flow diagram explaining an operation of the parameter reference processing function mounted in such a connector.

In “S001” in FIG. 6, the parameter reference processing function decides whether or not to be linkage between different field devices by referring to a preset connector parameter, and in the case of deciding that it is not the linkage between different field devices, in “S002” in FIG. 6, the parameter reference processing function invokes processing of the inside of the same field device and skips to step “S009” in FIG. 6.

In the case of deciding that it is the linkage between different field devices in “S001” in FIG. 6, the parameter reference processing function decides whether or not to be an IP network by referring to the preset connector parameter in “S003” in FIG. 6, and in the case of deciding that it is not the IP network, in “S004” in FIG. 6, the parameter reference processing function invokes processing for non-IP network and skips to step “S009” in FIG. 6.

In the case of deciding that it is the IP network in “S003” in FIG. 6, in “S005” in FIG. 6, the parameter reference processing function invokes processing for IP network and decides whether or not to be a LAN by referring to the preset connector parameter in “S006” in FIG. 6, and in the case of deciding that it is not the LAN, in “S007” in FIG. 6, the parameter reference processing function invokes WAN-capable processing and skips to step “S009” in FIG. 6.

In the case of deciding that it is the LAN in “S006” in FIG. 6, in “S008” in FIG. 6, the parameter reference processing function invokes LAN-capable processing and skips to step “S009” in FIG. 6.

Finally, the parameter reference processing function executes the invoked processing in “S009” in FIG. 6

As a result of this, the parameter reference processing function of referring to a connector parameter set in a connector and invoking and executing necessary processing is mounted in the connector and thereby, it is compatible with a difference in network environment by changing the connector parameter set in the connector without changing the connector.

Also, in the flow diagram shown in FIG. 6, the processing invoked in step “S009” in FIG. 6 is collectively executed, but various processing may naturally be executed sequentially at the stage of invoking the processing.

The present application is based on Japanese Patent Application (No. 2006-158017) filed on Jun. 7, 2006, the contents of which are incorporated herein by reference.

1. A system for performing an operation of linkage between application programs operating on each of the plural field devices mutually connected through a network, comprising:
a first field device and a second field device, in which an application management function operating on an operating system respectively reads an application program, a slot and a connector out of a storage part and the application program, the slot and the connector are respectively activated and also the operating system in which the slot is registered in the application and the connector is registered in the slot runs,
wherein the application programs respectively operating on the first field device and the second field device make connection to a virtual channel configured by a pair of the connector activated in the first field device and the connector activated in the second field device through a channel interface configured by a pair of the slot activated in the first field device and the slot activated in the second field device and perform sending and receiving of data.

2. A system as claimed in claim 1, wherein the plural slots are registered in the application program.

3. A system as claimed in claim 1, wherein the plural connectors are registered in the one slot registered in the application.

4. A system as claimed in claim 1, wherein the plural applications operating on the same field device make connection to a virtual channel configured by a pair of the connectors through a channel interface configured by a pair of the slots and perform sending and receiving of data.

5. A system as claimed in claim 1, wherein a parameter reference processing function of referring to a preset connector parameter and invoking and executing necessary processing is mounted in the connector.

6. A system as claimed in claim 5, wherein
in the case of deciding that sending and receiving of the data are not linkage between different field devices by referring to the connector parameter, the parameter reference processing function invokes processing of the inside of the same field device and executes the processing,
in the case of deciding that environment of the network is not an IP network by referring to the connector parameter, the parameter reference processing function invokes processing for non-IP network and executes the processing,
in the case of deciding that environment of the network is the IP network by referring to the connector parameter, the parameter reference processing function invokes processing for IP network,
in the case of deciding that environment of the network is not a LAN by referring to the connector parameter, the parameter reference processing function invokes WAN-capable processing and executes the processing together with the processing for IP network, and
in the case of deciding that environment of the network is the LAN by referring to the connector parameter, the parameter reference processing function invokes LAN-capable processing and executes the processing together with the processing for IP network.

7. A system as claimed in claim 1, wherein the connector mounted compatibly with a non-IP network is activated when environment of the network is not an IP network, and the connector mounted compatibly with a WAN is activated when environment of the network is the IP network and is not a LAN, and the connector mounted compatibly with the LAN is activated when environment of the network is the IP network and is the LAN.

8. A field device for performing an operation of linkage between plural application programs operating on the same field device, comprising:
an operating system;
an application management function; and
a storage part,
wherein the application management function operating on an operating system respectively reads a first application program, a first slot and a first connector out of the storage part and the first application program, the first slot and the first connector are respectively activated and also the operating system in which the first slot is registered in the first application program and the first connector is registered in the first slot runs and the application management function operating on the operating system respectively reads a second application program, a second slot and a second connector out of the storage part and the second application program, the second slot and the second connector are respectively activated and also the operating system in which the second slot is registered in the second application program and the second connector is registered in the second slot runs, and the first application program and the second application program make connection to a virtual channel configured by a pair of the first connector and the second connector through a channel interface configured by a pair of the first slot and the second slot and perform sending and receiving of data.
